(19) United States
(12) Patent Application Publication
(10) Pub. No.: US 2018/0357242 A1
(43) Pub. Date: Dec. 13, 2018

(54) GENERATING A SYNCHRONIZED MULTIMEDIA SOCIAL MEDIA PROFILE

(71) Applicant: International Business Machines Corporation, Armonk, NY (US)

(72) Inventors: Ilse Breedvelt, Manotick (CA); Tara Statchuk, Kars (CA)

(21) Appl. No.: 15/902,034

(22) Filed: Feb. 22, 2018

Related U.S. Application Data
(63) Continuation of application No. 15/621,099, filed on Jun. 13, 2017.

(51) Int. Cl. G06F 17/30; G06Q 10/10; G06Q 50/00; G06N 5/02; G06K 9/00

(52) U.S. Cl. CPC G06F 17/30056; G06Q 10/101; G06Q 50/01; G06K 9/00308; G06N 5/025; G06F 17/30029

(57) ABSTRACT

The present invention provides a method, system, and computer program product of generating a synchronized multimedia social media profile. In an embodiment, the present invention includes receiving profile parameter data indicating preferences of a user, obtaining, from social media channels, social data associated with the user based on the profile parameter data over a time frame, where the social data includes at least sentiment data, reaction data, image data, and topic data, generating digital music corresponding with at least the sentiment data and the reaction data, over the time frame, generating digital visual imagery corresponding with at least the image data and the topic data, over the time frame, and outputting a digital multimedia presentation including the generated digital music and the generated digital visual imagery, where the generated digital music and the generated digital visual imagery are rendered in a synchronized manner.

### BACKGROUND

The present disclosure relates to social media, and more specifically, to generating a synchronized multimedia social media profile.

### SUMMARY

The present invention provides a computer implemented method, a system, and a computer program product of generating a synchronized multimedia social media profile. In an exemplary embodiment, the computer implemented method, the system, and the computer program product include (1) receiving, by a computer system, profile parameter data indicating preferences of a user, (2) obtaining, by the computer system, from social media channels, social data associated with the user based on the profile parameter data over a time frame, where the social data includes at least sentiment data, reaction data, image data, and topic data, (3) generating, by the computer system, digital music corresponding with at least the sentiment data and the reaction data, over the time frame, (4) generating, by the computer system, digital visual imagery corresponding with at least the image data and the topic data, over the time frame, and (5) outputting, by the computer system, a digital multimedia presentation including the generated digital music and the generated digital visual imagery, where the generated digital music and the generated digital visual imagery are rendered in a synchronized manner.

### BRIEF DESCRIPTION OF THE DRAWINGS

FIG. 1A depicts a flowchart in accordance with an exemplary embodiment of the present invention.

FIG. 1B depicts a block diagram in accordance with an exemplary embodiment of the present invention.

FIG. 2A depicts a flowchart in accordance with an embodiment of the present invention.

FIG. 2B depicts a flowchart in accordance with an embodiment of the present invention.

FIG. 3 depicts a flowchart in accordance with an embodiment of the present invention.

FIG. 4 depicts a graphical display in accordance with an embodiment of the present invention.

FIG. 5A depicts a graphical display in accordance with an embodiment of the present invention.

FIG. 5B depicts a graph in accordance with an embodiment of the present invention.

FIG. 6 depicts a computer system in accordance with an exemplary embodiment of the present invention.

FIG. 7 depicts a cloud computing environment according to various embodiments of the present invention.

FIG. 8 depicts abstraction model layers according to various embodiments of the present invention.

### DETAILED DESCRIPTION

The present invention provides a computer implemented method, a system, and a computer program product of generating a synchronized multimedia social media profile. In an exemplary embodiment, the computer implemented method, the system, and the computer program product include (1) receiving, by a computer system, profile parameter data indicating preferences of a user, (2) obtaining, by the computer system, from social media channels, social data associated with the user based on the profile parameter data over a time frame, where the social data includes at least sentiment data, reaction data, image data, and topic data, (3) generating, by the computer system, digital music corresponding with at least the sentiment data and the reaction data, over the time frame, (4) generating, by the computer system, digital visual imagery corresponding with at least the image data and the topic data, over the time frame, and (5) outputting, by the computer system, a digital multimedia presentation including the generated digital music and the generated digital visual imagery, where the generated digital music and the generated digital visual imagery are rendered in a synchronized manner. In an embodiment, the profile parameter data includes at least presentation duration data indicating a duration of the digital multimedia presentation, time frame data indicating the time frame, music data indicating a style of music, and social media channel data indicating the social media channels. In an embodiment, the sentiment data indicates sentiment levels of the user, based on social posts of the user from the social media channels over the time frame. In an embodiment, the reaction data indicates at least one of likes of the user from the social media channels over the time frame and emoticons used by the user from the social media channels over the time frame.

In an embodiment, the image data indicates at least one of color data indicating colors of digital images associated with the user from the social media channels over the time frame and facial expression data indicating facial expressions of the user in digital images of the user from the social media channels over the time frame. In an embodiment, the topic data indicates topics of digital images associated with the user from the social media channels over the time frame. In a further embodiment, the computer implemented method, the system, and the computer program product further include extracting text data from text associated with the digital images. In a further embodiment, the social data further includes third party reaction data associated with other users, where the third party reaction data indicates at least one of likes of the other users with respect to social posts of the user from the social media channels over the time frame and emoticons of the other users with respect to the social posts of the user from the social media channels over the time frame.

### Definitions

Social Media

Social media are computer-mediated technologies that facilitate the creation and sharing of information, ideas, career interests and other forms of expression via virtual communities and networks. Social media Social media are interactive Web 2.0 Internet-based applications. User-generated content, such as text posts or comments, digital photos or videos, and data generated through all online interactions, are the lifeblood of social media. Users create service-specific profiles for the website or app that are designed and maintained by the social media organization. Social media facilitate the development of online social networks by connecting a user's profile with those of other individuals or groups.

Social media use web-based technologies, desktop computers and mobile technologies (e.g., smartphones and tablet computers) to create highly interactive platforms through which individuals, communities and organizations can share, co-create, discuss, and modify user-generated content or pre-made content posted online. They introduce substantial and pervasive changes to communication between businesses, organizations, communities and individuals. Social media changes the way individuals and large organizations communicate. Social media operate in a dialogic transmission system (many sources to many receivers).

Current social media profile pages allow a user to provide images of the user and a background picture of the user. The user can provide the user's musical interests in the user's profile description.

Current Technologies

Current technology allows for text analysis to generate music such that it creates music based on text and allows for sentiment analysis in social media posts (e.g., Tweets) of a user to determine a musical playlist for the user. Also, current technology allows a user to add multiple self-portraits on social media to display the user's emotion. Current technology allows for using existing three-dimensional space information in motion capture scenes and object information of animation to create videos. In addition, current technology allows for generating multimedia accompaniments to broadcast data (e.g., social data). Also, current technology allows for the compilation and presentation of user activity information from social media channels.

Problems Current Technologies

Current technology does not couple music to an associated animation with matching representations, does not analyze images and topics to determine the associated animation, and does not generate the music and does not generate animations. Also, current technology fails to create and synchronize the content of a multimedia presentation with a user's sentiments over time. Namely, current technology fails to combine music with the sentiments identified in the social activities of a user into an integrated personality presentation.

Problems with Social Media Profiles

Current social media profiles fail to convey the personalities/kinds of personality of the users associated with such profiles. Users desire to express themselves more than their profile pictures can convey. Often a profile picture of a user is not enough to tell others what kind of person that the user is. Also, the user's describing the user in a profile description is limited to facts. Others could view the user's timeline, but such a timeline would only be a moment in time, and would not necessarily reflect the moods and emotions of the user. There is a need to express and convey who a user are beyond just the facts associated with the user.

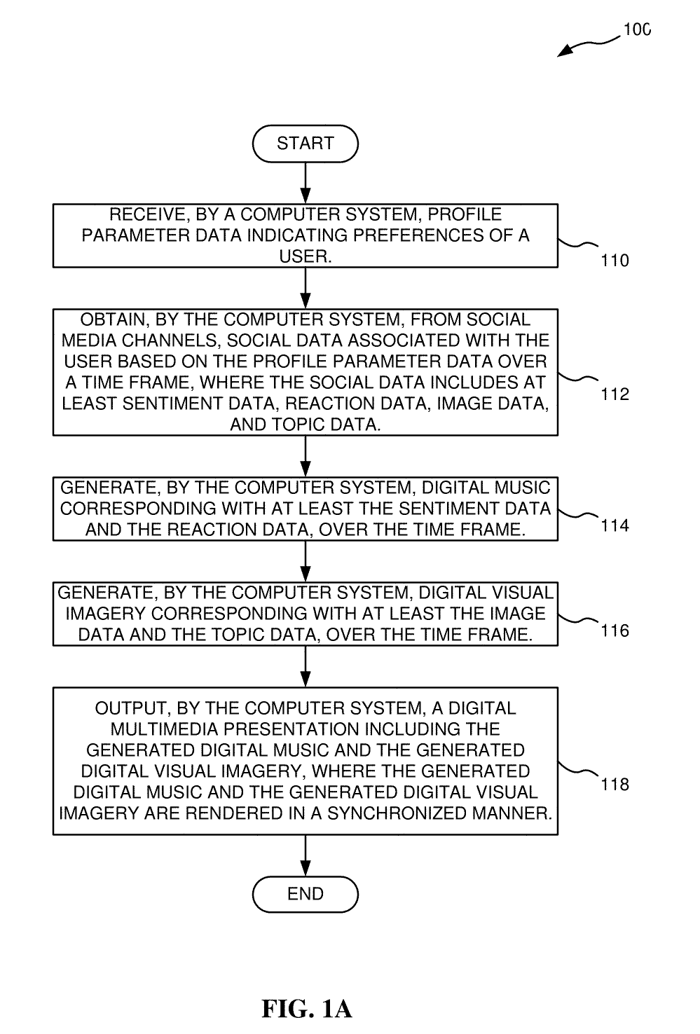

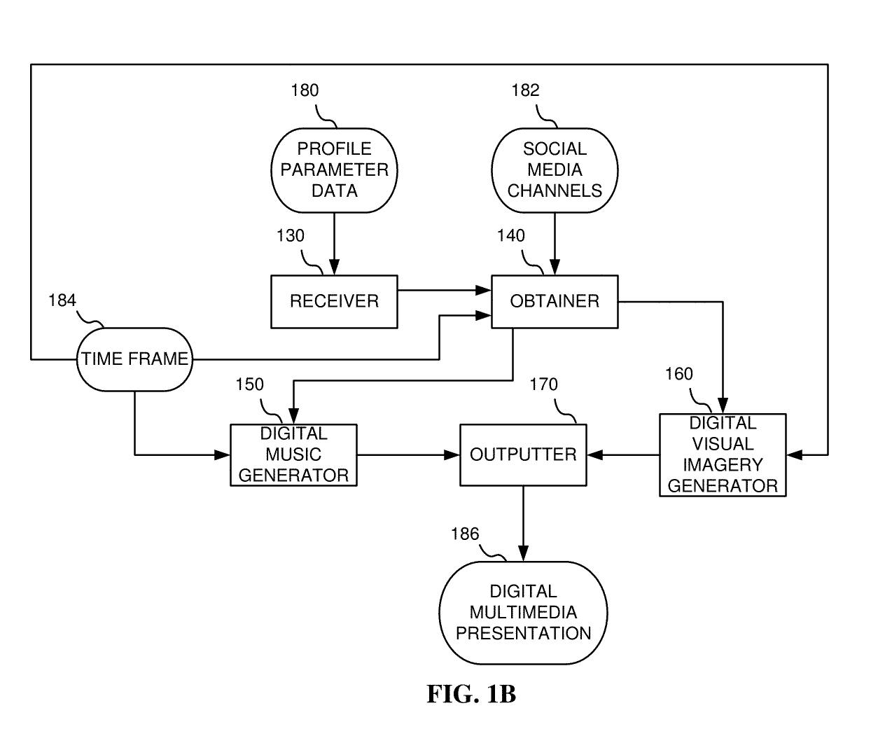

Referring to FIG. 1A, in an exemplary embodiment, the present invention is configured to perform an operation 110 of receiving, by a computer system, profile parameter data indicating preferences of a user, an operation 112 of obtaining, by the computer system, from social media channels, social data associated with the user based on the profile parameter data over a time frame, where the social data includes at least sentiment data, reaction data, image data, and topic data, an operation 114 of generating, by the computer system, digital music corresponding with at least the sentiment data and the reaction data, over the time frame, an operation 116 of generating, by the computer system, digital visual imagery corresponding with at least the image data and the topic data, over the time frame, and an operation 118 of outputting, by the computer system, a digital multimedia presentation including the generated digital music and the generated digital visual imagery, where the generated digital music and the generated digital visual imagery are rendered in a synchronized manner.

In an embodiment, the present invention generates an animated multi-media profile representation of a user. For example, the present invention could synchronize generated music with generated visual elements, where the generated music comes from sentiments captured in online posts, messages, reactions (e.g., likes) and images of the user, and where the generated visual elements come from the same posts, messages and images, which are all shared on social media by the profile holder/user over a period of time. Specifically, the present invention could change the profile representation of the user based on the life experiences and sentiments of the user. Additionally, the present invention could allow the user to express her or his personality in a dynamic manner via the user's social media profile. In an embodiment, because the present invention allows the user to change some parameters associated with the social media profile of the user, the present invention allows the user to influence a resulting multimedia presentation associated with the social media profile of the user, without requiring the user to modify the music or images in the multimedia presentation.

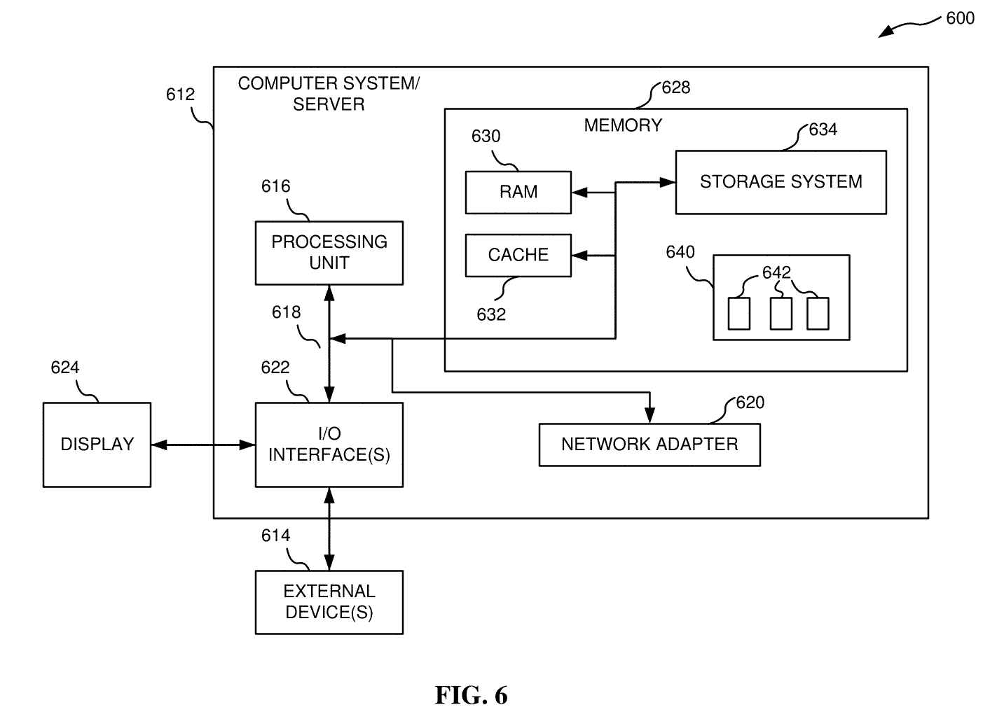

In an exemplary embodiment, the computer system is a standalone computer system, such as computer system 600 shown in FIG. 6, a network of distributed computers, where at least some of the computers are computer systems such as computer system 600 shown in FIG. 6, or a cloud computing node server, such as computer system 600 shown in FIG. 6. In an embodiment, the computer system is a computer system 600 as shown in FIG. 6, that executes a generating a synchronized multimedia social media profile script or computer software application that carries out the operations of at least method 100. In an embodiment, the computer system is a computer system/server 612 as shown in FIG. 6, that executes a generating a synchronized multimedia social media profile script or computer software application that carries out the operations of at least method 100. In an embodiment, the computer system is a processing unit 616 as shown in FIG. 6, that executes a generating a synchronized multimedia social media profile script or computer software application that carries out the operations of at least method 100. In an embodiment, the computer system is a computer system 600 as shown in FIG. 6, that executes a generating a synchronized multimedia social media profile script or computer software application that carries out at least operations 110, 112, 114, 116, and 118. In an embodiment, the computer system is a computer system/server 612 as shown in FIG. 6, that executes a generating a synchronized multimedia social media profile script or computer software application that carries out at least operations 110, 112, 114, 116, and 118. In an embodiment, the computer system is a processing unit 616 as shown in FIG. 6, that executes a generating a synchronized multimedia social media profile script or computer software application that carries out at least operations 110, 112, 114, 116, and 118.

Referring to FIG. 1B, in an exemplary embodiment, the present invention includes a receiver 130, an obtainer 140, a digital music generator 150, a digital visual imagery generator 160, and an outputter 170. In an embodiment, receiver 130 is configured to receive profile parameter data 180 indicating preferences of a user. In an embodiment, receiver 130 includes a computer system, such as computer system 600 as shown in FIG. 6, performing operation 110. In an embodiment, receiver 130 includes a computer system, such as computer system/server 612 as shown in FIG. 6, performing operation 110. In an embodiment, receiver 130 includes a computer system, such as processing unit 616 as shown in FIG. 6, performing operation 110. In an embodiment, receiver 130 is implemented as computer software executing on a computer system, such as computer system 600 as shown in FIG. 6, such that the computer system performs operation 110. In an embodiment, receiver 130 is implemented as computer software executing on a computer system, such as computer system/server 612 as shown in FIG. 6, such that the computer system performs operation 110. In an embodiment, receiver 130 is implemented as computer software executing on a computer system, such as processing unit 616 as shown in FIG. 6 such that the computer system performs operation 110. In an embodiment, receiver 130 performs operation 110 as computer software executing on a processor of receiver 130.

In an embodiment, obtainer 140 is configured to obtain from social media channels 182 social data associated with the user based on profile parameter data 180 over a time frame 184, where the social data includes at least sentiment data, reaction data, image data, and topic data. In an embodiment, obtainer 140 includes a computer system, such as computer system 600 as shown in FIG. 6, performing operation 112. In an embodiment, obtainer 140 includes a computer system, such as computer system/server 612 as shown in FIG. 6, performing operation 112. In an embodiment, obtainer 140 includes a computer system, such as processing unit 616 as shown in FIG. 6, performing operation 112. In an embodiment, obtainer 140 is implemented as computer software executing on a computer system, such as computer system 600 as shown in FIG. 6, such that the computer system performs operation 112. In an embodiment, obtainer 140 is implemented as computer software executing on a computer system, such as computer system/server 612 as shown in FIG. 6, such that the computer system performs operation 112. In an embodiment, obtainer 140 is implemented as computer software executing on a computer system, such as processing unit 616 as shown in FIG. 6 such that the computer system performs operation 112. In an embodiment, obtainer 140 performs operation 112 as computer software executing on a processor of obtainer 140.

In an embodiment, digital music generator 150 is configured to generate digital music corresponding with at least the sentiment data and the reaction data, over time frame 184. In an embodiment, digital music generator 150 includes a computer system, such as computer system 600 as shown in FIG. 6, performing operation 114. In an embodiment, digital music generator 150 includes a computer system, such as computer system/server 612 as shown in FIG. 6, performing operation 114. In an embodiment, digital music generator 150 includes a computer system, such as processing unit 616 as shown in FIG. 6, performing operation 114. In an embodiment, digital music generator 150 is implemented as computer software executing on a computer system, such as computer system 600 as shown in FIG. 6, such that the computer system performs operation 114. In an embodiment, digital music generator 150 is implemented as computer software executing on a computer system, such as computer system/server 612 as shown in FIG. 6, such that the computer system performs operation 114. In an embodiment, digital music generator 150 is implemented as computer software executing on a computer system, such as processing unit 616 as shown in FIG. 6 such that the computer system performs operation 114. In an embodiment, digital music generator 150 performs operation 114 as computer software executing on a processor of digital music generator 150.

In an embodiment, digital visual imagery generator 160 is configured to generate digital visual imagery corresponding with at least the image data and the topic data, over time frame 184. In an embodiment, digital visual imagery generator 160 includes a computer system, such as computer system 600 as shown in FIG. 6, performing operation 116. In an embodiment, digital visual imagery generator 160 includes a computer system, such as computer system/server 612 as shown in FIG. 6, performing operation 116. In an embodiment, digital visual imagery generator 160 includes a computer system, such as processing unit 616 as shown in FIG. 6, performing operation 116. In an embodiment, digital visual imagery generator 160 is implemented as computer software executing on a computer system, such as computer system 600 as shown in FIG. 6, such that the computer system performs operation 116. In an embodiment, digital visual imagery generator 160 is implemented as computer software executing on a computer system, such as computer system/server 612 as shown in FIG. 6, such that the computer system performs operation 116. In an embodiment, digital visual imagery generator 160 is implemented as computer software executing on a computer system, such as processing unit 616 as shown in FIG. 6 such that the computer system performs operation 116. In an embodiment, digital visual imagery generator 160 performs operation 116 as computer software executing on a processor of digital visual imagery generator 160.

In an embodiment, outputter 170 is configured to output a digital multimedia presentation 186 including the generated digital music and the generated digital visual imagery, where the generated digital music and the generated digital visual imagery are rendered in a synchronized manner. In an embodiment, outputter 170 includes a computer system, such as computer system 600 as shown in FIG. 6, performing operation 118. In an embodiment, outputter 170 includes a computer system, such as computer system/server 612 as shown in FIG. 6, performing operation 118. In an embodiment, outputter 170 includes a computer system, such as processing unit 616 as shown in FIG. 6, performing operation 118. In an embodiment, outputter 170 is implemented as computer software executing on a computer system, such as computer system 600 as shown in FIG. 6, such that the computer system performs operation 118. In an embodiment, outputter 170 is implemented as computer software executing on a computer system, such as computer system/server 612 as shown in FIG. 6, such that the computer system performs operation 118. In an embodiment, outputter 170 is implemented as computer software executing on a computer system, such as processing unit 616 as shown in FIG. 6 such that the computer system performs operation 118. In an embodiment, outputter 170 performs operation 118 as computer software executing on a processor of outputter 170.

### Generating Digital Music

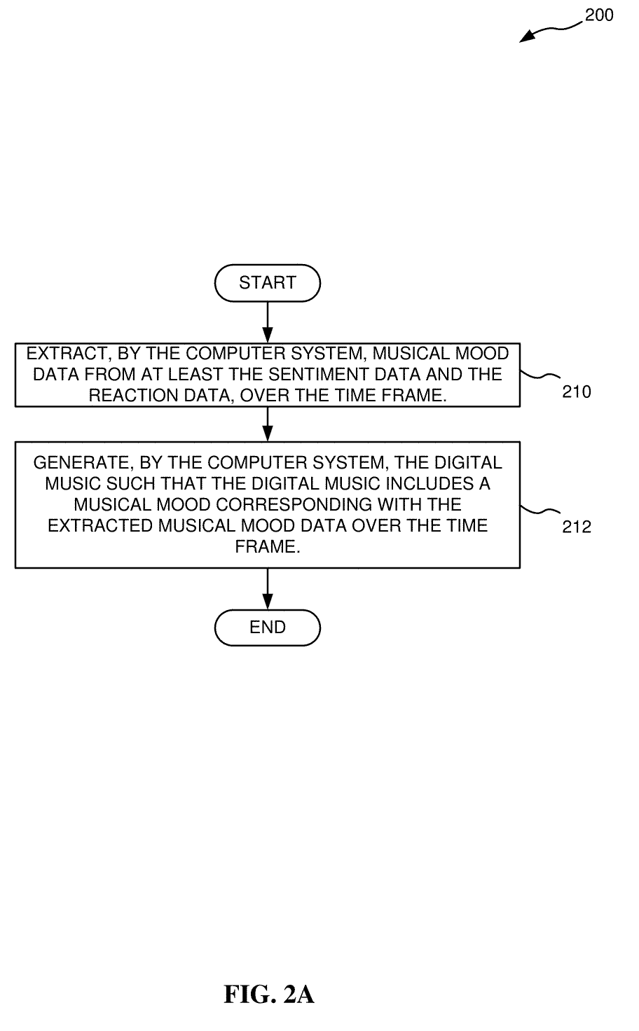

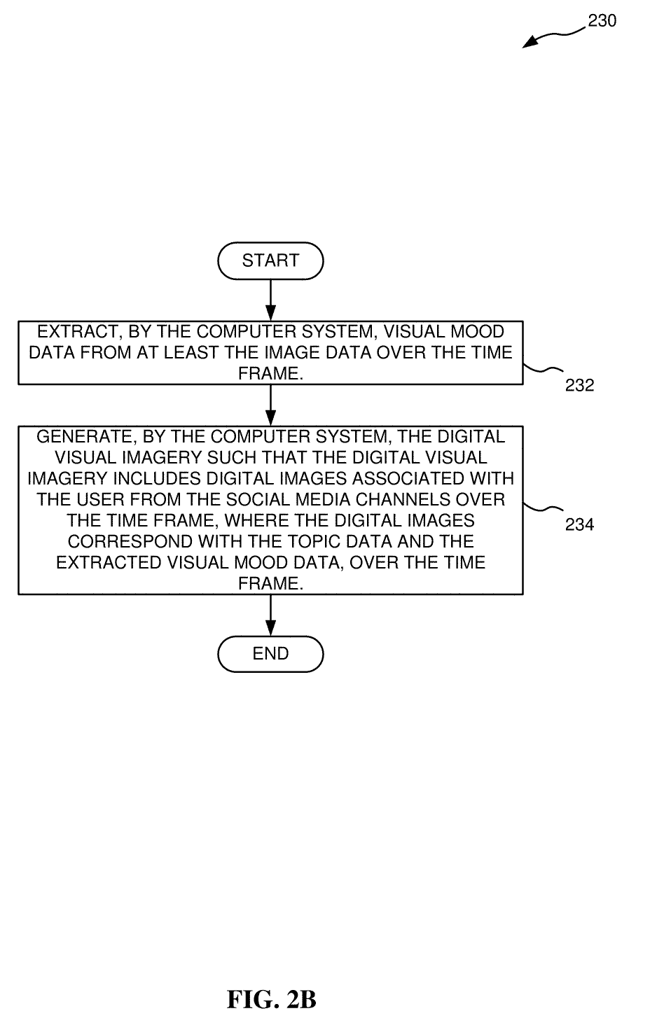

In an exemplary embodiment, the generating the digital music includes (a) extracting, by the computer system, musical mood data from at least the sentiment data and the reaction data, over the time frame, and (b) generating, by the computer system, the digital music such that the digital music includes a musical mood corresponding with the extracted musical mood data over the time frame. Referring to FIG. 2A, in an exemplary embodiment, generating digital music operation 114 includes an operation 210 of extracting, by the computer system, musical mood data from at least the sentiment data and the reaction data, over the time frame, and an operation 212 of generating, by the computer system, the digital music such that the digital music includes a musical mood corresponding with the extracted musical mood data over the time frame.

In an embodiment, digital music generator 150 includes a computer system 600 as shown in FIG. 6, that executes a generating a synchronized multimedia social media profile script or computer software application that carries out the operations of at least method 200. In an embodiment, digital music generator 150 includes a computer system/server 612 as shown in FIG. 6, that executes a generating a synchronized multimedia social media profile script or computer software application that carries out the operations of at least method 200. In an embodiment, digital music generator 150 includes a processing unit 616 as shown in FIG. 6, that executes a generating a synchronized multimedia social media profile script or computer software application that carries out the operations of at least method 200. In an embodiment, digital music generator 150 includes a computer system 600 as shown in FIG. 6, that executes a generating a synchronized multimedia social media profile script or computer software application that carries out at least operations 210 and 212. In an embodiment, digital music generator 150 includes a computer system/server 612 as shown in FIG. 6, that executes a generating a synchronized multimedia social media profile script or computer software application that carries out at least operations 210 and 212. In an embodiment, digital music generator 150 includes a processing unit 616 as shown in FIG. 6, that executes a generating a synchronized multimedia social media profile script or computer software application that carries out at least operations 210 and 212.

In an embodiment, digital music generator 150 is configured to extract musical mood data from at least the sentiment data and the reaction data, over time frame 184. In an embodiment, digital music generator 150 includes a computer system, such as computer system 600 as shown in FIG. 6, performing operation 210. In an embodiment, digital music generator 150 includes a computer system, such as computer system/server 612 as shown in FIG. 6, performing operation 210. In an embodiment, digital music generator 150 includes a computer system, such as processing unit 616 as shown in FIG. 6, performing operation 210. In an embodiment, digital music generator 150 is implemented as computer software executing on a computer system, such as computer system 600 as shown in FIG. 6, such that the computer system performs operation 210. In an embodiment, digital music generator 150 is implemented as computer software executing on a computer system, such as computer system/server 612 as shown in FIG. 6, such that the computer system performs operation 210. In an embodiment, digital music generator 150 is implemented as computer software executing on a computer system, such as processing unit 616 as shown in FIG. 6 such that the computer system performs operation 210. In an embodiment, digital music generator 150 extracts musical mood data from at least the sentiment data and the reaction data, over time frame 184 as computer software executing on a processor of digital music generator 150.

In an embodiment, digital music generator 150 is configured to generate the digital music such that the digital music includes a musical mood corresponding with the extracted musical mood data over time frame 184. In an embodiment, digital music generator 150 includes a computer system, such as computer system 600 as shown in FIG. 6, performing operation 212. In an embodiment, digital music generator 150 includes a computer system, such as computer system/server 612 as shown in FIG. 6, performing operation 212. In an embodiment, digital music generator 150 includes a computer system, such as processing unit 616 as shown in FIG. 6, performing operation 212. In an embodiment, digital music generator 150 is implemented as computer software executing on a computer system, such as computer system 600 as shown in FIG. 6, such that the computer system performs operation 212. In an embodiment, digital music generator 150 is implemented as computer software executing on a computer system, such as computer system/server 612 as shown in FIG. 6, such that the computer system performs operation 212. In an embodiment, digital music generator 150 is implemented as computer software executing on a computer system, such as processing unit 616 as shown in FIG. 6 such that the computer system performs operation 212. In an embodiment, digital music generator 150 generates the digital music such that the digital music includes a musical mood corresponding with the extracted musical mood data over time frame 184 as computer software executing on a processor of digital music generator 150. For example, digital music generator 150 could output digital music computer files storing the digital music such that the digital music includes a musical mood corresponding with the extracted musical mood data over time frame 184.

### Generating Digital Visual Imagery

In an exemplary embodiment, the generating the digital visual imagery includes (a) extracting, by the computer system, visual mood data from at least the image data over the time frame and (b) generating, by the computer system, the digital visual imagery such that the digital visual imagery includes digital images associated with the user from the social media channels over the time frame, where the digital images correspond with the topic data and the extracted visual mood data, over the time frame. Referring to FIG. 2B, in an exemplary embodiment, generating digital visual imagery operation 116 includes an operation 232 of extracting, by the computer system, visual mood data from at least the image data over the time frame and an operation 234 of generating, by the computer system, the digital visual imagery such that the digital visual imagery includes digital images associated with the user from the social media channels over the time frame, where the digital images correspond with the topic data and the extracted visual mood data, over the time frame.

In an embodiment, digital visual imagery generator 160 includes a computer system 600 as shown in FIG. 6, that executes a generating a synchronized multimedia social media profile script or computer software application that carries out the operations of at least method 230. In an embodiment, digital visual imagery generator 160 includes a computer system/server 612 as shown in FIG. 6, that executes a generating a synchronized multimedia social media profile script or computer software application that carries out the operations of at least method 230. In an embodiment, digital visual imagery generator 160 includes a processing unit 616 as shown in FIG. 6, that executes a generating a synchronized multimedia social media profile script or computer software application that carries out the operations of at least method 230. In an embodiment, digital visual imagery generator 160 includes a computer system 600 as shown in FIG. 6, that executes a generating a synchronized multimedia social media profile script or computer software application that carries out at least operations 232 and 234. In an embodiment, digital visual imagery generator 160 includes a computer system/server 612 as shown in FIG. 6, that executes a generating a synchronized multimedia social media profile script or computer software application that carries out at least operations 232 and 234. In an embodiment, digital visual imagery generator 160 includes a processing unit 616 as shown in FIG. 6, that executes a generating a synchronized multimedia social media profile script or computer software application that carries out at least operations 232 and 234.

In an embodiment, digital visual imagery generator 160 is configured to extract visual mood data from at least the image data over time frame 184. In an embodiment, digital visual imagery generator 160 includes a computer system, such as computer system 600 as shown in FIG. 6, performing operation 232. In an embodiment, digital visual imagery generator 160 includes a computer system, such as computer system/server 612 as shown in FIG. 6, performing operation 232. In an embodiment, digital visual imagery generator 160 includes a computer system, such as processing unit 616 as shown in FIG. 6, performing operation 232. In an embodiment, digital visual imagery generator 160 is implemented as computer software executing on a computer system, such as computer system 600 as shown in FIG. 6, such that the computer system performs operation 232. In an embodiment, digital visual imagery generator 160 is implemented as computer software executing on a computer system, such as computer system/server 612 as shown in FIG. 6, such that the computer system performs operation 232. In an embodiment, digital visual imagery generator 160 is implemented as computer software executing on a computer system, such as processing unit 616 as shown in FIG. 6 such that the computer system performs operation 232. In an embodiment, digital visual imagery generator 160 extracts visual mood data from at least the image data over time frame 184 as computer software executing on a processor of digital visual imagery generator 160.

In an embodiment, digital visual imagery generator 160 is configured to generate the digital visual imagery such that the digital visual imagery includes digital images associated with the user from social media channels 182 over time frame 184, where the digital images correspond with the topic data and the extracted visual mood data, over time frame 184. In an embodiment, digital visual imagery generator 160 includes a computer system, such as computer system 600 as shown in FIG. 6, performing operation 234. In an embodiment, digital visual imagery generator 160 includes a computer system, such as computer system/server 612 as shown in FIG. 6, performing operation 234. In an embodiment, digital visual imagery generator 160 includes a computer system, such as processing unit 616 as shown in FIG. 6, performing operation 234. In an embodiment, digital visual imagery generator 160 is implemented as computer software executing on a computer system, such as computer system 600 as shown in FIG. 6, such that the computer system performs operation 234. In an embodiment, digital visual imagery generator 160 is implemented as computer software executing on a computer system, such as computer system/server 612 as shown in FIG. 6, such that the computer system performs operation 234. In an embodiment, digital visual imagery generator 160 is implemented as computer software executing on a computer system, such as processing unit 616 as shown in FIG. 6 such that the computer system performs operation 234. In an embodiment, digital visual imagery generator 160 generates the digital visual imagery such that the digital visual imagery includes digital images associated with the user from social media channels 182 over time frame 184, where the digital images correspond with the topic data and the extracted visual mood data, over time frame 184 as computer software executing on a processor of digital visual imagery generator 160.

For example, digital visual imagery generator 160 could output digital visual imagery computer files storing the digital visual imagery such that the digital visual imagery includes digital images associated with the user from social media channels 182 over time frame 184, where the digital images correspond with the topic data and the extracted visual mood data, over time frame 184. In a particular embodiment, the digital images include still images associated with the user from social media channels 182 over time frame 184, where the digital images correspond with the topic data and the extracted visual mood data, over time frame 184. In a particular embodiment, the digital images include moving images, such as videos and animated images (e.g., animated .gif files), associated with the user from social media channels 182 over time frame 184, where the digital images correspond with the topic data and the extracted visual mood data, over time frame 184.

### Outputting Digital Multimedia Presentation

Background Colors

In an exemplary embodiment, the outputting the digital multimedia presentation includes displaying, by the computer system, background colors corresponding with the extracted musical mood data, over the time frame. In an embodiment, outputting operation 118 includes displaying, by the computer system, background colors corresponding with the extracted musical mood data, over the time frame. In an embodiment, outputter 170 is configured to display background colors corresponding with the extracted musical mood data, over time frame 184. In an embodiment, outputter 170 includes a computer system, such as computer system 600 as shown in FIG. 6, displaying background colors corresponding with the extracted musical mood data, over time frame 184. In an embodiment, outputter 170 includes a computer system, such as computer system/server 612 as shown in FIG. 6, displaying background colors corresponding with the extracted musical mood data, over time frame 184. In an embodiment, outputter 170 includes a computer system, such as processing unit 616 as shown in FIG. 6, displaying background colors corresponding with the extracted musical mood data, over time frame 184. For example, outputter 170 could display, on a computer display of the computer system, the background colors corresponding with the extracted musical mood data, over time frame 184. Also, for example, outputter 170 could display, on a computer display of outputter 170, the background colors corresponding with the extracted musical mood data, over time frame 184.

In an embodiment, outputter 170 is implemented as computer software executing on a computer system, such as computer system 600 as shown in FIG. 6, such that the computer system displays background colors corresponding with the extracted musical mood data, over time frame 184. In an embodiment, outputter 170 is implemented as computer software executing on a computer system, such as computer system/server 612 as shown in FIG. 6, such that the computer system displays background colors corresponding with the extracted musical mood data, over time frame 184. In an embodiment, outputter 170 is implemented as computer software executing on a computer system, such as processing unit 616 as shown in FIG. 6, such that the computer system displays background colors corresponding with the extracted musical mood data, over time frame 184. In an embodiment, outputter 170 displays background colors corresponding with the extracted musical mood data, over time frame 184 as computer software executing on a processor of outputter 170.

Digital Images and Generated Digital Music

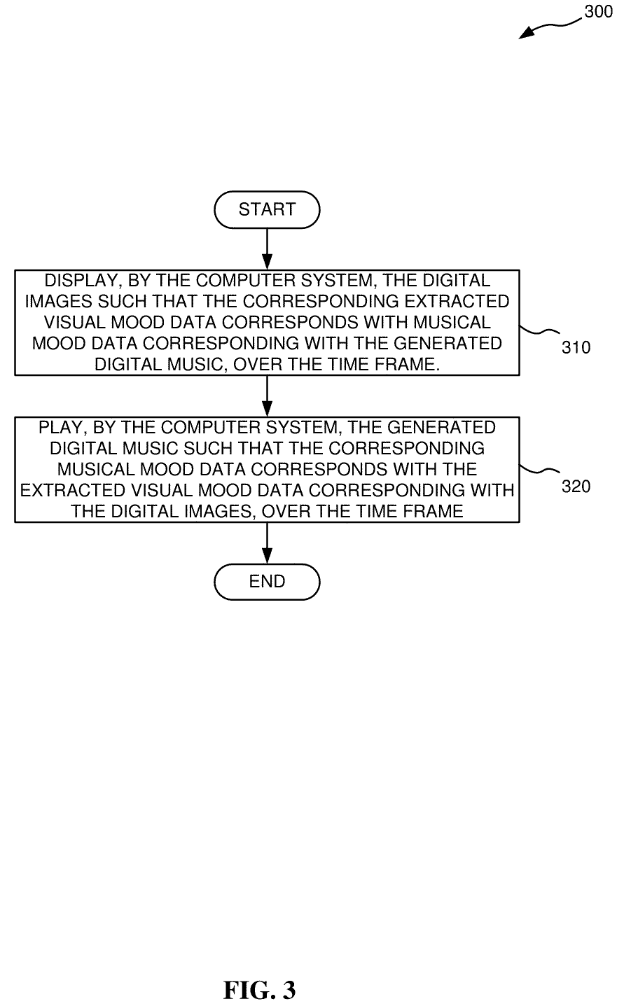

In an exemplary embodiment, the outputting the digital multimedia presentation includes (a) displaying, by the computer system, the digital images such that the corresponding extracted visual mood data corresponds with musical mood data corresponding with the generated digital music, over the time frame, and (b) playing, by the computer system, the generated digital music such that the corresponding musical mood data corresponds with the extracted visual mood data corresponding with the digital images, over the time frame. Referring to FIG. 3, in an exemplary embodiment, outputting operation 118 includes an operation 310 of displaying, by the computer system, the digital images such that the corresponding extracted visual mood data corresponds with musical mood data corresponding with the generated digital music, over the time frame, and an operation 320 of playing, by the computer system, the generated digital music such that the corresponding musical mood data corresponds with the extracted visual mood data corresponding with the digital images, over the time frame.

In an embodiment, outputter 170 includes a computer system 600 as shown in FIG. 6, that executes a generating a synchronized multimedia social media profile script or computer software application that carries out the operations of at least method 300. In an embodiment, outputter 170 includes a computer system/server 612 as shown in FIG. 6, that executes a generating a synchronized multimedia social media profile script or computer software application that carries out the operations of at least method 300. In an embodiment, outputter 170 includes a processing unit 616 as shown in FIG. 6, that executes a generating a synchronized multimedia social media profile script or computer software application that carries out the operations of at least method 300. In an embodiment, outputter 170 includes a computer system 600 as shown in FIG. 6, that executes a generating a synchronized multimedia social media profile script or computer software application that carries out at least operations 310 and 320. In an embodiment, outputter 170 includes a computer system/server 612 as shown in FIG. 6, that executes a generating a synchronized multimedia social media profile script or computer software application that carries out at least operations 310 and 320. In an embodiment, outputter 170 includes a processing unit 616 as shown in FIG. 6, that executes a generating a synchronized multimedia social media profile script or computer software application that carries out at least operations 310 and 320.

In an embodiment, outputter 170 is configured to display the digital images such that the corresponding extracted visual mood data corresponds with musical mood data corresponding with the generated digital music, over time frame 184. In an embodiment, outputter 170 includes a computer system, such as computer system 600 as shown in FIG. 6, performing operation 310. In an embodiment, outputter 170 includes a computer system, such as computer system/server 612 as shown in FIG. 6, performing operation 310. In an embodiment, outputter 170 includes a computer system, such as processing unit 616 as shown in FIG. 6, performing operation 310. In an embodiment, outputter 170 is implemented as computer software executing on a computer system, such as computer system 600 as shown in FIG. 6, such that the computer system performs operation 310. In an embodiment, outputter 170 is implemented as computer software executing on a computer system, such as computer system/server 612 as shown in FIG. 6, such that the computer system performs operation 310. In an embodiment, outputter 170 is implemented as computer software executing on a computer system, such as processing unit 616 as shown in FIG. 6 such that the computer system performs operation 310. In an embodiment, outputter 170 displays the digital images such that the corresponding extracted visual mood data corresponds with musical mood data corresponding with the generated digital music, over time frame 184. For example, outputter 170 could display, on a computer display of the computer system, the digital images such that the corresponding extracted visual mood data corresponds with musical mood data corresponding with the generated digital music, over time frame 184. Also, for example, outputter 170 could display, on a computer display of outputter 170, the digital images such that the corresponding extracted visual mood data corresponds with musical mood data corresponding with the generated digital music, over time frame 184.

In an embodiment, outputter 170 is configured to play the generated digital music such that the corresponding musical mood data corresponds with the extracted visual mood data corresponding with the digital images, over time frame 184. In an embodiment, outputter 170 includes a computer system, such as computer system 600 as shown in FIG. 6, performing operation 320. In an embodiment, outputter 170 includes a computer system, such as computer system/server 612 as shown in FIG. 6, performing operation 320. In an embodiment, outputter 170 includes a computer system, such as processing unit 616 as shown in FIG. 6, performing operation 320. In an embodiment, outputter 170 is implemented as computer software executing on a computer system, such as computer system 600 as shown in FIG. 6, such that the computer system performs operation 320. In an embodiment, outputter 170 is implemented as computer software executing on a computer system, such as computer system/server 612 as shown in FIG. 6, such that the computer system performs operation 320. In an embodiment, outputter 170 is implemented as computer software executing on a computer system, such as processing unit 616 as shown in FIG. 6 such that the computer system performs operation 320. In an embodiment, outputter 170 plays the generated digital music such that the corresponding musical mood data corresponds with the extracted visual mood data corresponding with the digital images, over time frame 184. For example, outputter 170 could play, on at least one audio output device (e.g., speaker) of the computer system, the generated digital music such that the corresponding musical mood data corresponds with the extracted visual mood data corresponding with the digital images, over time frame 184. Also, for example, outputter 170 could play, on at least one audio output device (e.g., speaker) of outputter 170, the generated digital music such that the corresponding musical mood data corresponds with the extracted visual mood data corresponding with the digital images, over time frame 184.

Visual Rendering

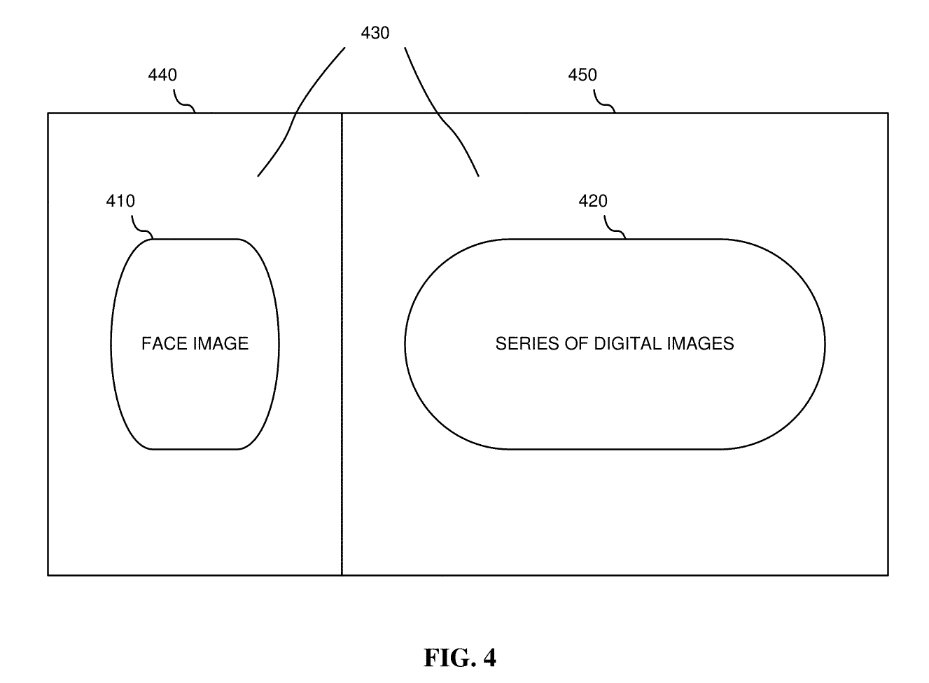

In an exemplary embodiment, the outputting the digital multimedia presentation includes displaying, by the computer system, a face image, where the face image is a digital image depicting the user, such that the extracted visual mood data corresponding with the face image corresponds with musical mood data corresponding with the generated digital music, over the time frame. Referring to FIG. 4, in an exemplary embodiment, outputting operation 118 includes displaying, by the computer system, a face image 410, where face image 410 is a digital image depicting the user, such that the extracted visual mood data corresponding with face image 410 corresponds with musical mood data corresponding with the generated digital music, over time frame 184. For example, face image 410 could be a digital photograph of the user. In another example, face image 410 could be computer generated image depicting the user. In an embodiment, outputting operation 118 includes displaying, by the computer system, face image 410 in a region 440 of a computer display of the computer system.

In an exemplary embodiment, the outputting the digital multimedia presentation includes displaying, by the computer system, a series of digital images associated with the user from the social media channels over the time frame, where the digital images correspond with the topic data and the extracted visual mood data, over the time frame. Referring to FIG. 4, in an exemplary embodiment, outputting operation 118 includes displaying, by the computer system, a series of digital images 420 associated with the user from social media channels 182 over time frame 184, where the digital images correspond with the topic data and the extracted visual mood data, over time frame 184. For example, series of digital images 420 could be a series of digital photographs of the user. In another example, series of digital images 420 could be a series of computer generated images depicting the user. For example, series of digital images 420 could be a series of digital photographs associated with the user. In another example, series of digital images 420 could be a series of computer generated images associated with the user. In an embodiment, outputting operation 118 includes displaying, by the computer system, series of digital images 420 in a region 450 of a computer display of the computer system. In an embodiment, region 440 is adjacent to region 450.

In an exemplary embodiment, the outputting the digital multimedia presentation includes displaying, by the computer system, background colors corresponding with the extracted musical mood data, over the time frame, in a region of a computer display of the computer system where the face image is displayed and in a region of the computer display of the computer system where the series of digital images is displayed. Referring to FIG. 4, in an embodiment, outputting operation 118 includes displaying, by the computer system, background colors 430 corresponding with the extracted musical mood data, over time frame 184, in region 440 of a computer display of the computer system where face image 410 is displayed and in region 450 of the computer display of the computer system where series of digital images 420 is displayed.

### EXAMPLE

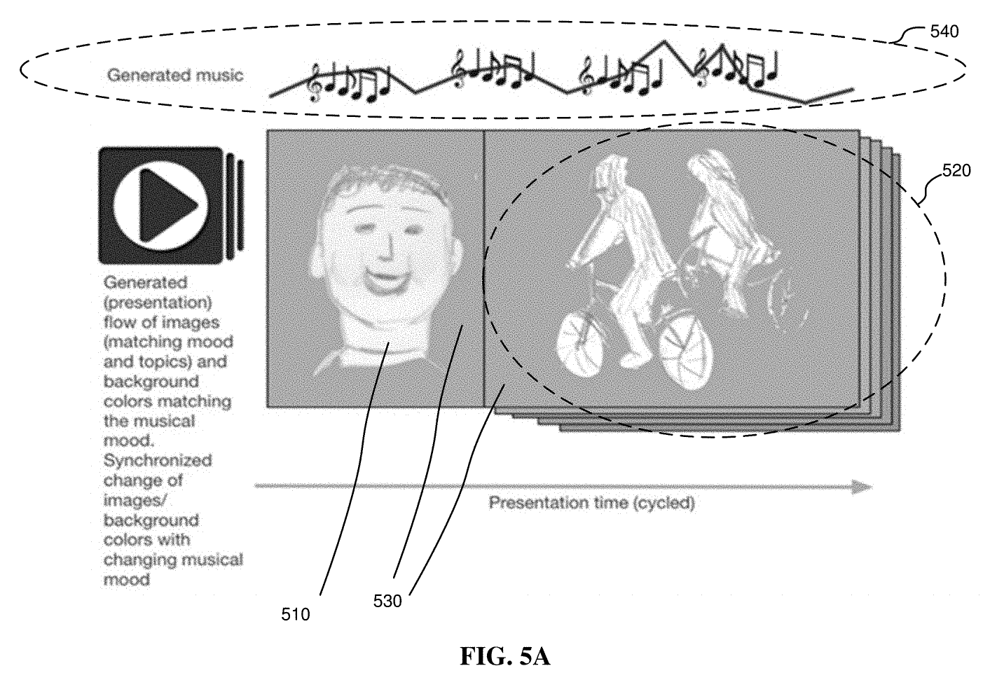

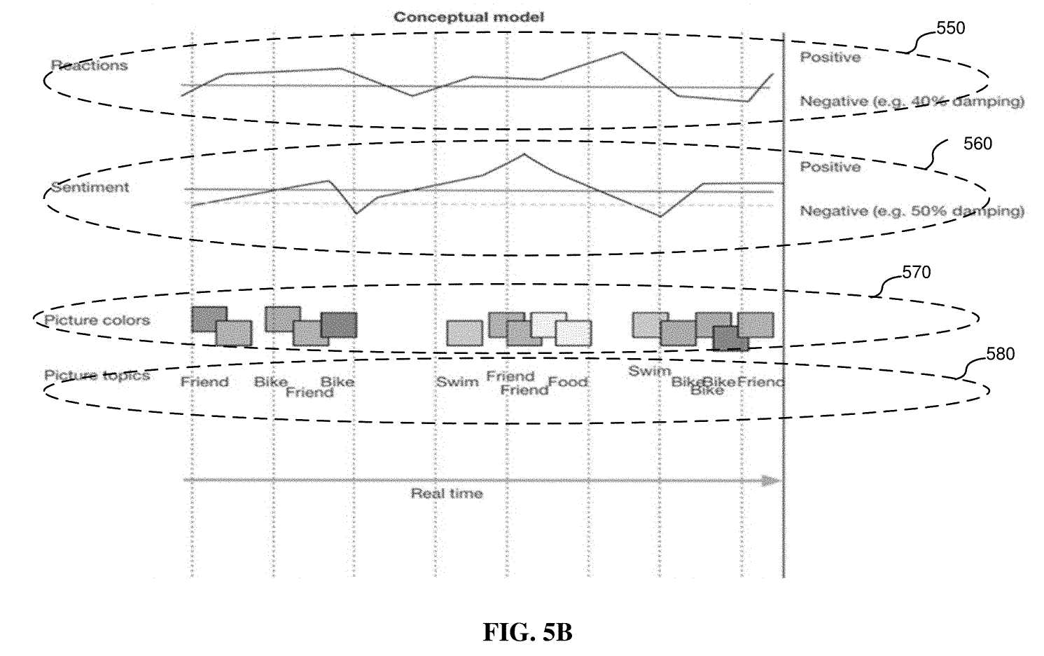

Referring to FIG. 5A, the present invention could display a photograph/image of a social media user (e.g., photograph/image 510) with an associated multimedia presentation (e.g., a series of images 520 and coordinated music 540) that lasts a certain amount of time, among background colors 530. For example, the present invention could allow a user to set up a new profile representation, where the profile of the user is set up with parameters (with defaults and ability to change). In a specific example, the parameters could be the following: (i) how long the multimedia presentation should be (e.g., 1 minute, 30 seconds), (ii) the time frame that the multimedia representation should be based upon (e.g., the last 3 months), (iii) what music style should be applied (e.g., plano, hip hop, bass guitar), (iv) what social media channels should be used for sentiments (e.g., Facebook®, Instagram®, Twitter®), and (v) where the images should come from (e.g., Instagram®, Facebook®).

Referring to FIG. 5B, in light of the inputted parameters, the present invention could harvest sentiments associated with the user over time (e.g., sentiments 550), likes and emoticons associated with the user around postings of the user over time (e.g., reactions 560), and images associated with the user. Specifically, the present invention could extract from the images topics of interest over time (via object recognition) (e.g., picture topics 570), main colors over time (e.g. picture colors 580), and facial expressions of the user (for mood identification). Thereafter, the present invention could generate music (e.g., coordinated music 540) with a mood fitting the sentiments (e.g., sentiments 550) from the profile holder/user and reactions (likes and emoticons) (e.g., reactions 560) of the user over time, could generate a matching presentation, with the topics and images matching the moment of the mood over time, and could create a multimedia presentation (e.g., a series of images 520 and coordinated music 540), with background colors 530, as a means for personality expression for the user.

### Computer System

In an exemplary embodiment, the computer system is a computer system 600 as shown in FIG. 6. Computer system 600 is only one example of a computer system and is not intended to suggest any limitation as to the scope of use or functionality of embodiments of the present invention. Regardless, computer system 600 is capable of being implemented to perform and/or performing any of the functionality/operations of the present invention.

Computer system 600 includes a computer system/server 612, which is operational with numerous other general purpose or special purpose computing system environments or configurations. Examples of well-known computing systems, environments, and/or configurations that may be suitable for use with computer system/server 612 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices.

Computer system/server 612 may be described in the general context of computer system-executable instructions, such as program modules, being executed by a computer system. Generally, program modules may include routines, programs, objects, components, logic, and/or data structures that perform particular tasks or implement particular abstract data types. Computer system/server 612 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, computer system/server 612 in computer system 600 is shown in the form of a general-purpose computing device. The components of computer system/server 612 may include, but are not limited to, one or more processors or processing units 616, a system memory 628, and a bus 618 that couples various system components including system memory 628 to processor 616.

Bus 618 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 612 typically includes a variety of computer system readable media. Such media may be any available media that is accessible by computer system/server 612, and includes both volatile and non-volatile media, removable and non-removable media.

System memory 628 can include computer system readable media in the form of volatile memory, such as random access memory (RAM) 630 and/or cache memory 632. Computer system/server 612 may further include other removable/non-removable, volatile/non-volatile computer system storage media. By way of example only, storage system 634 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 618 by one or more data media interfaces. As will be further depicted and described below, memory 628 may include at least one program product having a set (e.g., at least one) of program modules that are configured to carry out the functions/operations of embodiments of the invention.

Program/utility 640, having a set (at least one) of program modules 642, may be stored in memory 628 by way of example, and not limitation. Exemplary program modules 642 may include an operating system, one or more application programs, other program modules, and program data. Each of the operating system, one or more application programs, other program modules, and program data or some combination thereof, may include an implementation of a networking environment. Program modules 642 generally carry out the functions and/or methodologies of embodiments of the present invention.

Computer system/server 612 may also communicate with one or more external devices 614 such as a keyboard, a pointing device, a display 624, one or more devices that enable a user to interact with computer system/server 612, and/or any devices (e.g., network card, modem, etc.) that enable computer system/server 612 to communicate with one or more other computing devices. Such communication can occur via Input/Output (I/O) interfaces 622. Still yet, computer system/server 612 can communicate with one or more networks such as a local area network (LAN), a general wide area network (WAN), and/or a public network (e.g., the Internet) via network adapter 620. As depicted, network adapter 620 communicates with the other components of computer system/server 612 via bus 618. It should be understood that although not shown, other hardware and/or software components could be used in conjunction with computer system/server 612. Examples, include, but are not limited to: microcode, device drivers, redundant processing units, external disk drive arrays, RAID systems, tape drives, and data archival storage systems.

### Cloud Computing

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

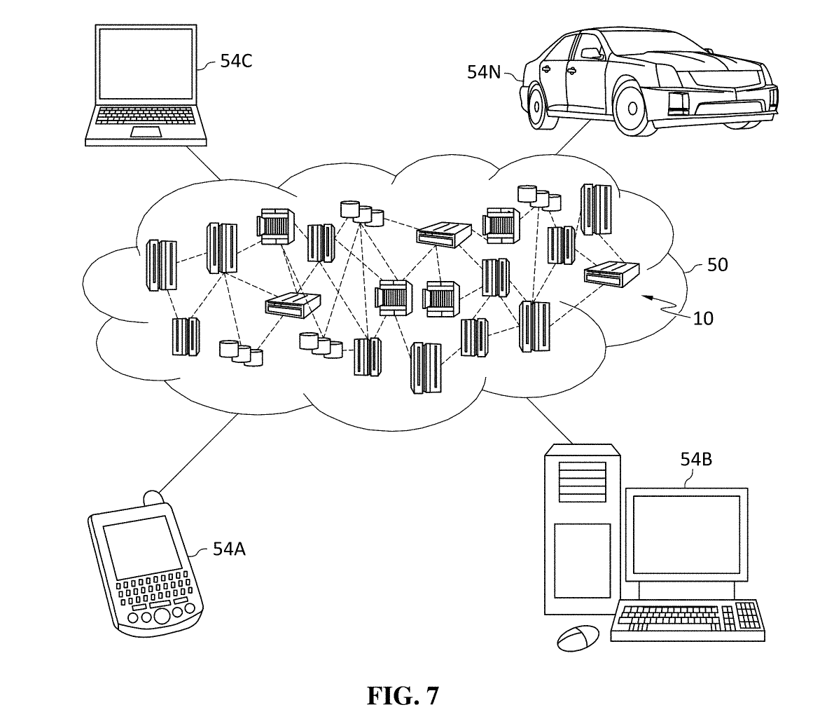

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

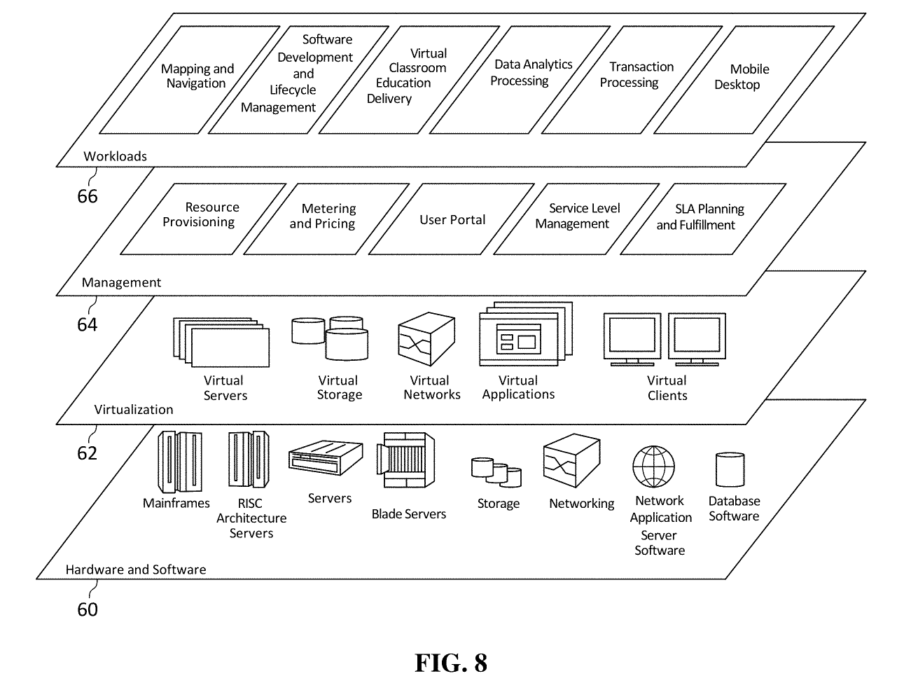

Referring now to FIG. 8, a set of functional abstraction layers provided by cloud computing environment 50 (FIGS. 5A and 5B) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes; RISC (Reduced Instruction Set Computer) architecture based servers; storage devices; networks and networking components. In some embodiments, software components include network application server software.

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and mobile desktop.

### Computer Program Product

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer implemented method comprising:
receiving, by a computer system, profile parameter data indicating preferences of a user,
wherein the profile parameter data comprises at least presentation duration data indicating a duration of the digital multimedia presentation, time frame data indicating the time frame, music data indicating a style of music, and social media channel data indicating the social media channels;
obtaining, by the computer system, from social media channels, social data associated with the user based on the profile parameter data over a time frame, wherein the social data comprises at least sentiment data, reaction data, image data, and topic data,
wherein the sentiment data indicates sentiment levels of the user, based on social posts of the user from the social media channels over the time frame,
wherein the reaction data indicates at least one of likes of the user from the social media channels over the time frame and emoticons used by the user from the social media channels over the time frame,
wherein the image data indicates at least one of color data indicating colors of digital images associated with the user from the social media channels over the time frame and facial expression data indicating facial expressions of the user in digital images of the user from the social media channels over the time frame,
wherein the topic data indicates topics of digital images associated with the user from the social media channels over the time frame;
generating, by the computer system, digital music corresponding with at least the sentiment data and the reaction data, over the time frame,
wherein the generating the digital music comprises:
extracting, by the computer system, musical mood data from at least the sentiment data and the reaction data, over the time frame, and
generating, by the computer system, the digital music such that the digital music comprises a musical mood corresponding with the extracted musical mood data over the time frame;
generating, by the computer system, digital visual imagery corresponding with at least the image data and the topic data, over the time frame,
wherein the generating the digital visual imagery comprises:
extracting, by the computer system, visual mood data from at least the image data over the time frame, and
generating, by the computer system, the digital visual imagery such that the digital visual imagery comprises digital images associated with the user from the social media channels over the time frame, wherein the digital images correspond with the topic data and the extracted visual mood data, over the time frame;
outputting, by the computer system, a digital multimedia presentation comprising the generated digital music and the generated digital visual imagery, wherein the generated digital music and the generated digital visual imagery are rendered in a synchronized manner; and
wherein the social data further comprises third party reaction data associated with other users, wherein the third party reaction data indicates at least one of likes of the other users with respect to social posts of the user from the social media channels over the time frame and emoticons of the other users with respect to the social posts of the user from the social media channels over the time frame.
